(19) United States
(12) Patent Application Publication
(10) Pub. No.: US 2016/0288791 A1
(43) Pub. Date: Oct. 6, 2016

(54) AUTOMATIC DRIVING SYSTEM FOR VEHICLE

(71) Applicants: Young-II PARK, Incheon (KR); Su-Min PARK, Incheon (KR)

(72) Inventor: Su-Min PARK, Incheon (KR)

(73) Assignees: Young-II PARK, Incheon (KR); Su-Min PARK, Incheon (KR)

(21) Appl. No.: 14/777,534

(22) PCT Filed: Mar. 18, 2014
(86) PCT No.: PCT/KR2014/002257

§ 371 Date: Sep. 16, 2015

(30) Foreign Application Priority Data
Apr. 1, 2013 (KR) 10-2013-0035003

(51) Int. Cl. B60W 30/18; G01C 21/34; B60W 30/09; B60W 10/18; B60W 10/20; G05D 1/00; B60W 10/06

(52) U.S. Cl. CPC B60W 30/18; G05D 1/0088; G01C 21/34; B60W 10/06; B60W 10/18; B60W 10/20; B60W 30/09

(57) ABSTRACT

The present invention relates to an automatic driving system for a vehicle, and more specifically, to an automatic driving system for a vehicle which controls a vehicle to be automatically driven to a destination in consideration of traffic signals and peripheral vehicles or objects, when a driver sets the destination in a navigation device. To this end, the system according to the present invention comprises: a mapping module for setting a driving lane by receiving route information set in a navigation device installed in a vehicle and then, converting a distance, direction, and rotation angle to actual measurement data; and a driving control module for having a vehicle be driven along the driving lane set by the mapping module.

### TECHNICAL FIELD

The present invention relates to an automatic driving system for a vehicle, and in particular to an automatic driving system for a vehicle wherein when a driver sets a destination on a navigation device, a vehicle can be controlled to be automatically driven to the set destination in consideration of traffic signals, nearby vehicles and things.

### BACKGROUND ART

When a driver sets a predetermined speed, a conventional automatic driving system in general allows to maintain the set speed unless the driver operates an accelerator. Such an automatic driving system in general is called an auto drive, an automatic, an auto cruise, etc.

The above automatic driving system is able to control the speed of a vehicle and a distance to a forward vehicle. Sensor detect a distance to a forward vehicle, thus controlling a throttle and a brake with the aid of a computer, whereupon the vehicle can be driven in safe while maintaining a safety distance between vehicles.

If a driver sets a predetermined speed on a road on which a high speed drive is available, the vehicle is controlled to be driven at the set speed. To this end, the driver does not need to operate an accelerator pedal for driving at the set speed, whereupon a driver's fatigue may be reduced a lot.

As illustrated in FIGS. 1 and 2, the Korean patent registration number 10-0180496 describes a technology on such an automatic driving system as an example. The technical features thereof will be described below. The automatic driving system wherein a user can drive a vehicle at a predetermined speed by selecting a manual or automatic driving includes a selection switching unit for selecting a predetermined vehicle among forward vehicles; a distance detection unit 4 for detecting a distance to a forward vehicle with the aid of a transceiver unit so as to measure to the vehicle detected by the selection switching unit; a distance setting unit 6 for setting a distance to the vehicle selected by the selection switching unit in proportion to a vehicle speed; an electronic control module 8 for outputting an acceleration and deceleration signal so as to control a safety distance to a forward vehicle in consideration of a signal detected by the distance detection unit 4 in accordance with a signal set by the distance setting unit 6; and a step motor “M” for maintaining a safety distance to a forward vehicle by controlling the revolution of an accelerator control motor in response to a signal outputted from the electronic control module 8.

The technology disclosed in the Korean patent registration number 10-0180496 has an advantage in the way that a driver can drive a vehicle at a predetermined speed while maintaining a distance to a forward vehicle in the inside of his vehicle unless the driver controls acceleration and deceleration, thus reducing any fatigue; however only a simple speed control is available, and a steering control of a vehicle is impossible. For this reason, the driver needs to control a steering handle, which still makes the driver feel fatigue.

### DISCLOSURE OF INVENTION

Accordingly, the present invention is made in an effort to improve the above-mentioned problems. It is an object of the present invention to provide an automatic driving system for a vehicle wherein when a driver sets a destination on a navigation device, a mapping module disposed in the inside of an automatic driving device receives a route information set on the navigation device and converts a distance, direction, and rotation angle into an actual measurement data with which the vehicle is actually driven, thus forming a driving lane, and a driving control module allows to control an accelerator, a brake and a steering device of the vehicle based on the driving lane, so the vehicle can be automatically driven to the set destination.

It is another object of the present invention to provide an automatic driving system for a vehicle wherein a driving control module disposed at an automatic driving device stores information on an accurate position of each wheel of a vehicle, an angle at which a wheel rotates when adjusting a steering device and the size of a wheel, so the vehicle can be accurately driven along a driving lane formed by the mapping module.

It is further another object of the present invention to provide an automatic driving system for a vehicle wherein a driving safety module disposed at an automatic driving device includes a wireless receiver unit for receiving in real time the information on a traffic signal from each signal lamp and detecting a signal of the signal lamp, whereupon the vehicle can be driven in compliance with the signal, thus being driven in safe at a crossroad, a crosswalk, etc.

It is still further another object of the present invention to provide an automatic driving system for a vehicle wherein when setting a mapping module, the width and number of lanes formed on a road are set, and there are provided a main driving lane on which a vehicle can be directly driven based on one among the lanes formed on a road, and an assistant driving lane which allows a vehicle to be driven on another lane, thus easily changing the lane in such a way to change the assistant driving lane to the main driving lane.

It is still further another object of the present invention to provide an automatic driving system for a vehicle wherein a position detection module is provided at an automatic driving device so as to accurately determine a lane on which a vehicle positions in a road, thus more accurately controlling a vehicle. The driving lane that a vehicle was driven before and an image taken by a camera can be stored in a storing unit. If the vehicle uses the same driving lane, the stored image can be compared with a currently taken image, thus more accurately controlling.

To achieve the above objects, there is provided an automatic driving system for a vehicle, which may include, but is not limited to, a mapping module which receives a route information set on a navigation device installed at a vehicle and converts a distance, a direction and a rotation angle into an actual measurement data and sets a driving lane; and a driving control module which allows the vehicle to be driven on the driving lane set by the mapping module.

It is characterized in that the driving control module is configured to store a vehicle information on a position of each wheel, a rotation angle of each wheel rotating when a steering device is operated, and a diameter of each wheel.

It is characterized in that the driving control module is configured to control an engine, a brake and the steering device in consideration of the vehicle information for the vehicle to be driven on a driving lane with the aid of an ECU (Electronic Control Unit) provided at the vehicle.

It is characterized in that there is further provided an error correction module which is able to correct a driving lane based on the current position of the vehicle received from the navigation device by comparing the current position of the vehicle received from the navigation device with the position on the driving lane.

It is characterized in that there is further provided a driving safety module which allows to prevent any collision in such a way to detect other vehicles or things near the vehicle with the aid of a distance detection sensor installed at front, rear, left and right sides of the vehicle.

It is characterized in that the driving safety module includes a wireless receiver unit which is able to receive a signal lamp information from a wireless transmitter unit installed at a signal lamp at a crossroad or a crosswalk.

It is characterized in that when setting a driving lane, the mapping module sets together information on a crossroad, a crosswalk, a tunnel, a signal lamp, a regulated speed of a road, and an exclusive frequency of each signal lamp.

It is characterized in that the mapping module is configured to store information on the width and number of the lanes formed on each road on which the vehicle is driven and form a main driving lane allowing the vehicle to be directly driven on any of the lanes formed on the road, and an assistant lane allowing the vehicle to be driven on other lanes.

It is characterized in that there is further provided a lane control module for detecting the lane in order for the vehicle not to deviate from the lane.

It is characterized in that the lane control module may include, but is not limited to, an image process module which is configured to process the images transmitted from a camera installed at a front side of the vehicle; and a lane detection module which is configured to determine each lane by analyzing the pattern of each lane in the images processed by the image process module.

In addition, it is characterized in that the lane control module may include, but is not limited to, an image process module for processing the images from a camera installed at a front side of a vehicle; and a lane detection module for determining each lane by analyzing the pattern of a corresponding lane in the image processed by the image process module.

Here, it is characterized in that a position detection module is further provided so as to detect the position of a vehicle. The position detection module allows to determine a lane on which a road positions in a road based on a lane information detected with the aid of the image process module and the lane detection module.

Meanwhile, it is characterized in that a position detection module may be further provided so as to detect the position of a vehicle. The position detection module may include a first transceiver device for transmitting and receiving a high frequency signal. At each side of a road, there is provided a second transceiver device for receiving the signal of the first transceiver device and transmitting a signal, with the second transceiver devices being disposed spaced apart from each other. The position detection module may determine a lane on which a vehicle positions in a road with the aid of a distance between two sides of a road and a width information of a lane based on a signal received through the first and second transceiver devices.

In addition, it is characterized in that a road state detection module is further provided so as to determine the stare of a road. The road state detection module is able to determine if there is any crack or dent on a road by analyzing the image taken by a camera disposed at a vehicle.

It is characterized in that there is further provided a storing unit for storing a driving lane on which a vehicle was driven before, and an image taken using a camera installed at a vehicle, and the above image is stored matching with the position of the driving lane.

In addition, it is characterized in that when a vehicle is driven on a road on which the vehicle was driven before, a vehicle is controlled comparing the image stored in the storing unit with the image being currently taken by the camera.

Meanwhile, it is characterized in that a wireless receiver unit may receive a geographical information of a parking lot transmitted through a wireless transceiver unit provided at a parking lot and an information of a space in which a vehicle is parking, and the mapping module may form a detailed driving lane so as to move and park a vehicle at a parking position in the parking lot from the current position of the vehicle.

Here, it is characterized in that there is further provided a position detection module for detecting the position of a vehicle. The position detection module may include a first transceiver device for transmitting and receiving a high frequency signal. At an edge portion of the parking lot, there is provided a third transceiver device for receiving a signal of the first transceiver device and transmitting a signal. The position detection module may measure the position of a vehicle with the aid of an edge portion detected based on a signal received through the first and third transceiver devices, and a geographical information of the parking lot.

In addition, it is characterized in that the current signal is determined in such a way that a signal lamp is extracted from the image taken by a camera provided at a vehicle, and the extracted signal lamp is compared with the image of the signal lamp stored by pattern in a driving control module.

### ADVANTAGEOUS EFFECTS

According to the present invention, when a driver sets a destination on a navigation device, a mapping module provided in the inside of an automatic driving device receives a route information set on the navigation device and converts a distance, direction and rotation angle into an actual measurement data with which a vehicle is actually driven, thus forming a driving lane. A driving control module allows a vehicle to be driven along the driving lane, while controlling an accelerator, brake and a steering device of a vehicle. To this end, the vehicle can be automatically driven to the destination.

The driving control module provided in an automatic driving device of the present invention may store information on an angle at which a wheel rotates when adjusting an accurate position of each wheel of a vehicle and a steering device and a size of each wheel, whereupon the vehicle can be accurately driven along a driving lane formed by the mapping module.

In the present invention, the driving safety module provided at the automatic driving device may include a wireless receiver unit, thus detecting a signal of a signal lamp by receiving in real time an information of a signal lamp from each signal lamp, so the vehicle can be drive in compliance with a signal, while being driven in safe at a crossroad and a crosswalk.

In addition, when setting a mapping module, the width and number of lanes formed on a road on which a vehicle is driven are set. There are formed a main driving lane allowing a vehicle to be directly driven on one of the lanes formed on the road, and an assistant driving lane allowing the vehicle to be driven on another lane. When changing the lane, the assistant driving lane is changed to a main driving lane, thus easily changing the lane.

In the present invention, the automatic driving device may include a position detection module, thus accurately determining a lane on which a vehicle positions in a road, whereupon it is possible to accurately control the vehicle. The storing unit may store a driving lane on which the vehicle was driven before and an image taken by a camera, so if the vehicle uses the sale driving lane, the stored image and an image being currently taken may be compared, thus more accurately controlling the vehicle.

### BRIEF DESCRIPTION OF DRAWINGS

FIG. 1 is a block diagram illustrating a conventional automatic driving system for a vehicle.

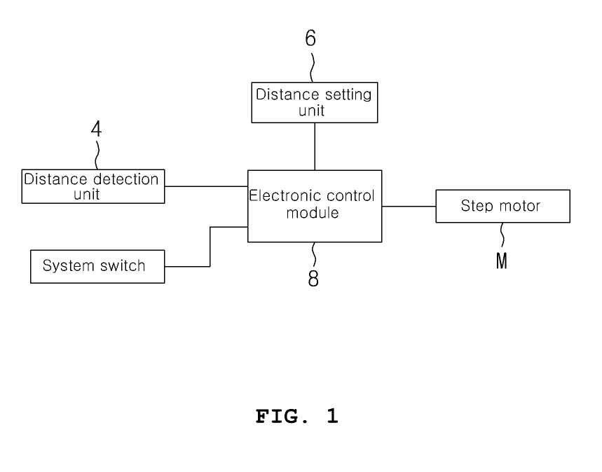

FIG. 2 is a circuit diagram illustrating a conventional automatic driving system for a vehicle.

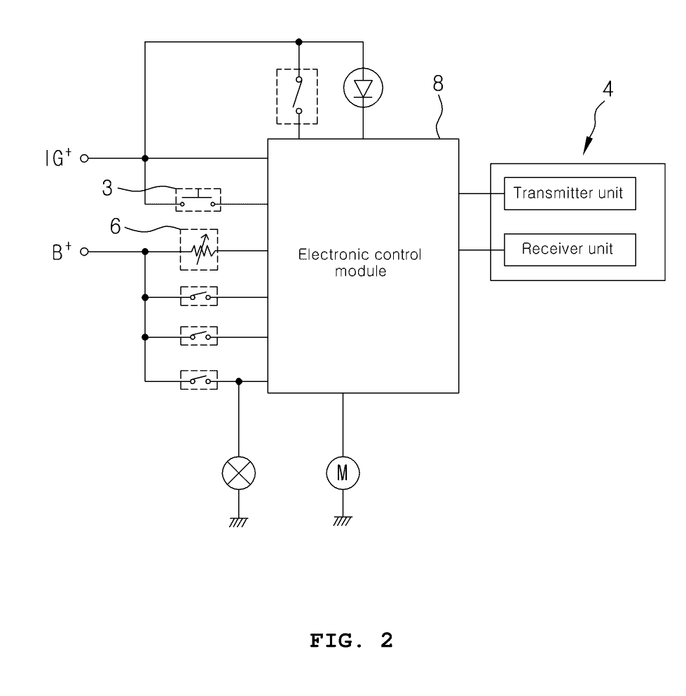

FIG. 3 is a schematic view illustrating a vehicle to which an automatic driving system for a vehicle has applied according to the present invention.

FIG. 4 is a block diagram illustrating an automatic driving system for a vehicle according to the present invention.

FIG. 5 is a conception view illustrating a signal lamp system installed at a crossroad according to the present invention.

FIG. 6 is a conception view illustrating a driving lane formed by a mapping module of an automatic driving system for a vehicle according to the present invention.

FIG. 7 is a block diagram illustrating an automatic driving system for a vehicle according to another exemplary embodiment of the present invention.

FIG. 8 is a block diagram illustrating an automatic driving system for a vehicle according to further another exemplary embodiment of the present invention.

FIG. 9 is a conception view illustrating a road according to an exemplary embodiment in FIG. 8.

FIG. 10 is a block diagram illustrating an automatic driving system for a vehicle according to still further another exemplary embodiment of the present invention.

FIG. 11 is a block diagram illustrating an automatic driving system for a vehicle according to still further another exemplary embodiment of the present invention.

### BEST MODES FOR CARRYING OUT THE INVENTION

The exemplary embodiments of the present invention will be described with reference to the accompanying drawings. The same elements in the drawings will be given the same reference numbers. The repeated descriptions on the same elements will be omitted. It should be understood that the present invention may be implemented in multiple different aspects and is not limited to the described contents.

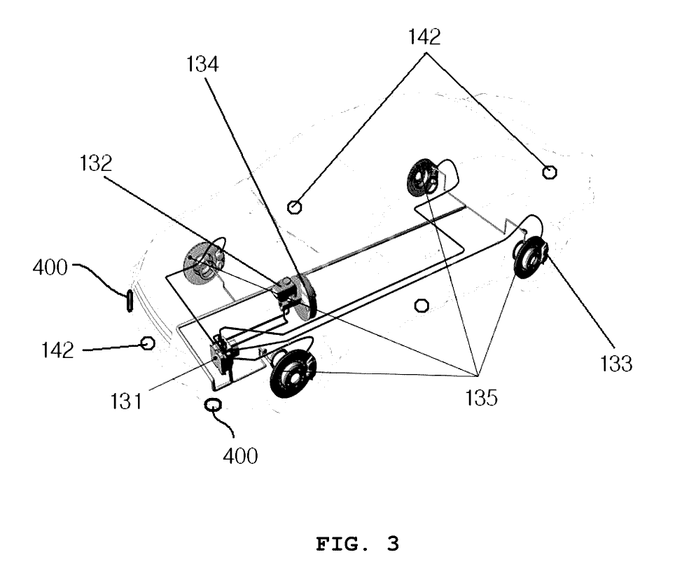

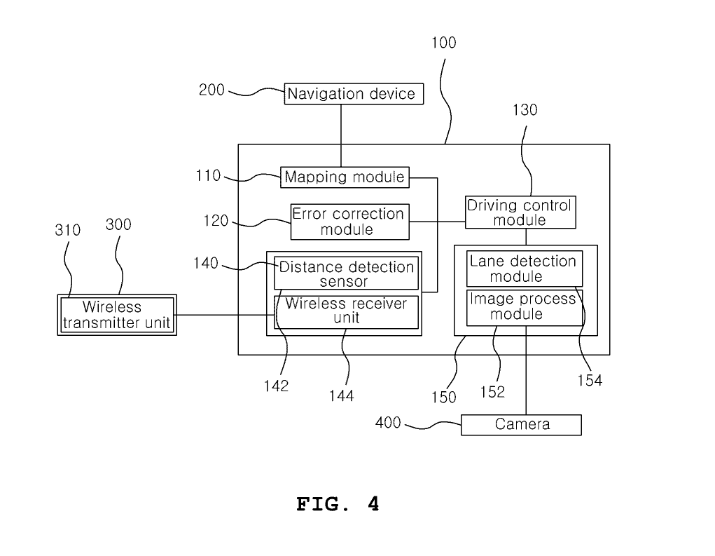

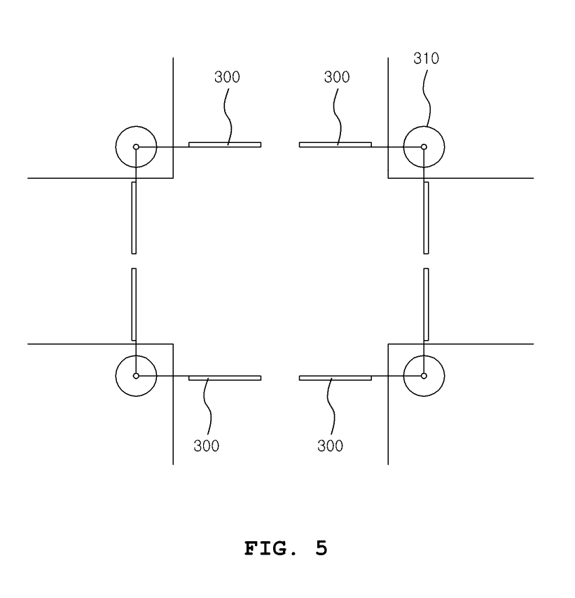

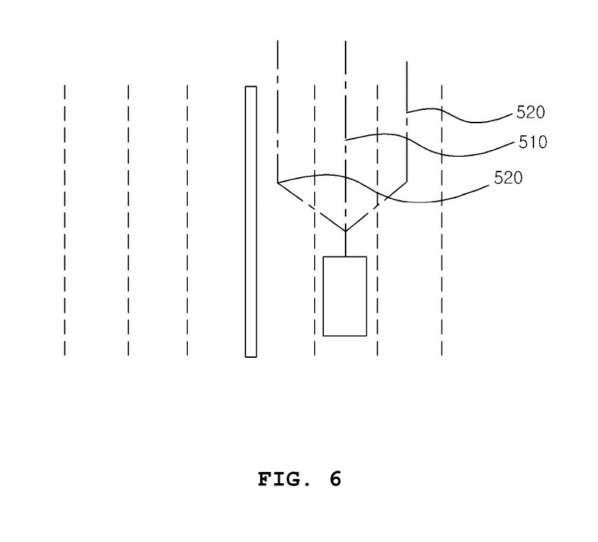

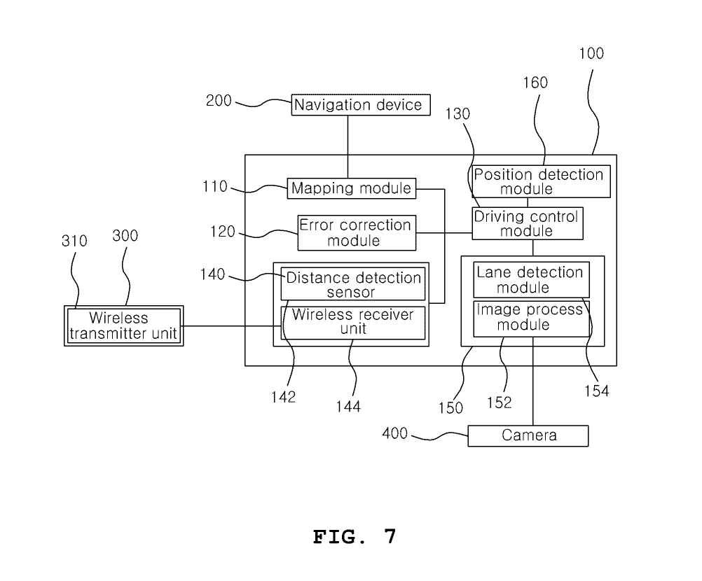

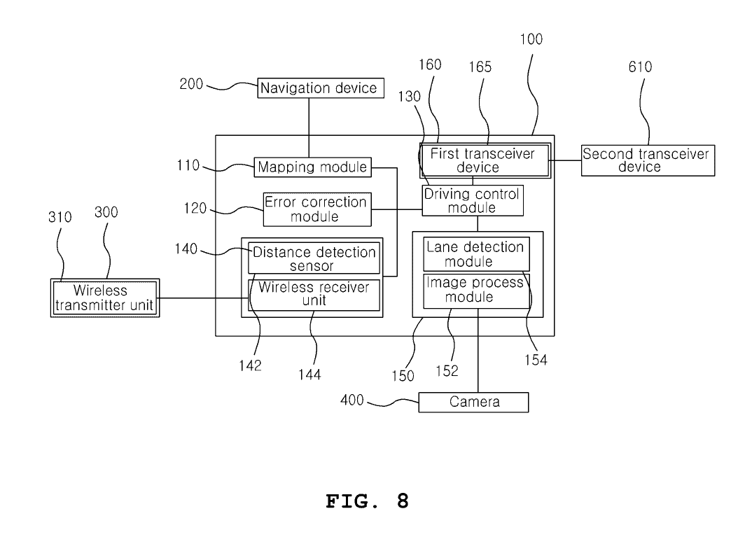

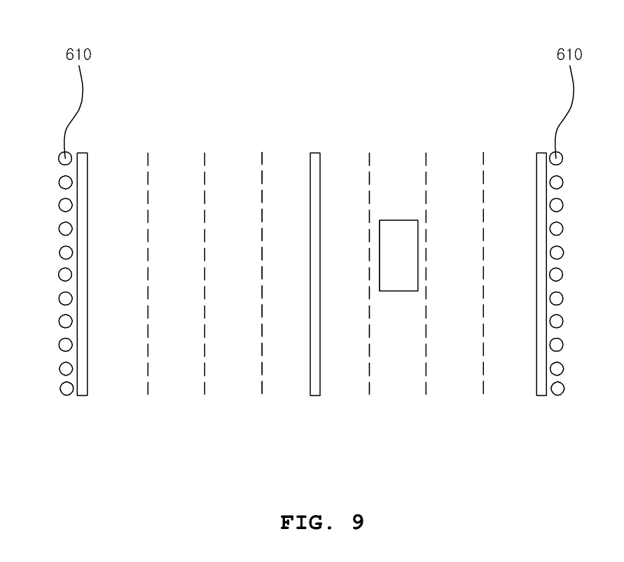

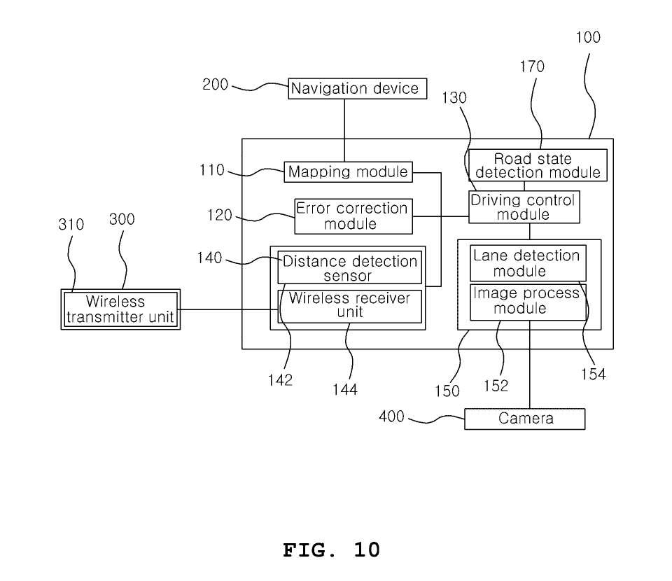

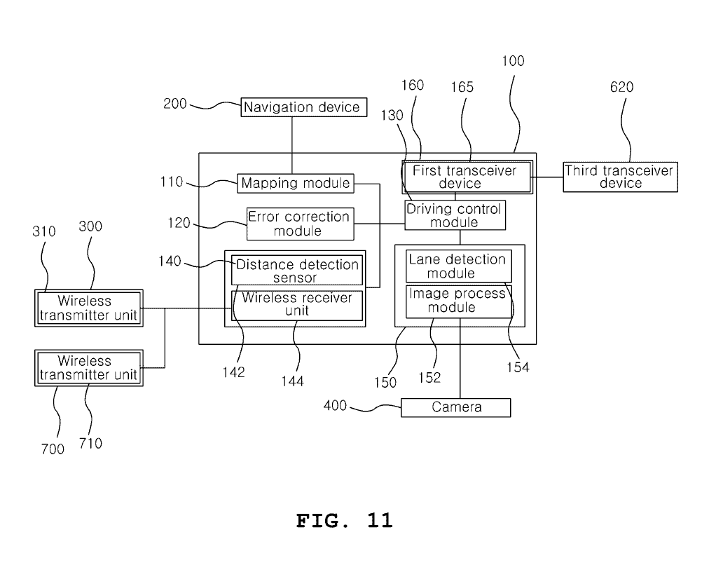

FIG. 3 is a schematic view illustrating a vehicle to which an automatic driving system for a vehicle has applied according to the present invention. FIG. 4 is a block diagram illustrating an automatic driving system for a vehicle according to the present invention. FIG. 5 is a conception view illustrating a signal lamp system installed at a crossroad according to the present invention. FIG. 6 is a conception view illustrating a driving lane formed by a mapping module of an automatic driving system for a vehicle according to the present invention. FIG. 7 is a block diagram illustrating an automatic driving system for a vehicle according to another exemplary embodiment of the present invention. FIG. 8 is a block diagram illustrating an automatic driving system for a vehicle according to further another exemplary embodiment of the present invention. FIG. 9 is a conception view illustrating a road according to an exemplary embodiment in FIG. 8. FIG. 10 is a block diagram illustrating an automatic driving system for a vehicle according to still further another exemplary embodiment of the present invention. FIG. 11 is a block diagram illustrating an automatic driving system for a vehicle according to still further another exemplary embodiment of the present invention.

The present invention is directed to an automatic driving system for a vehicle which is installed at a vehicle and allows for the vehicle to be automatically driven to a destination. As illustrated in FIGS. 3 and 4, it may include an automatic driving device 100 which allows to control a vehicle. The automatic driving device 100 may include, but is not limited to, a mapping module 110, an error correction module 120, a driving control module 130, and a driving safety module 140.

Here, the mapping module 110 is configured to receive a route information from the current position to a destination that a user sets on a navigation device 200 installed at a vehicle and to set a driving lane on which the vehicle may be actually driven. The driving lane may be set by converting a distance, a direction and a rotation angle in the received route information into an actual measurement data.

In addition, the driving control module 130 is configured to control the vehicle to be driven along a driving lane set by the mapping module 110. The driving control module 130 may control an engine 132, a brake 133 and a steering device 134 with the aid of a ECU (Electronic Control Unit) 131 installed at the vehicle.

At this time, the driving control module 130 is configured to store the information on the positions of wheels installed at the vehicle, the rotation angle of the wheels which rotate when operating the steering device 134, and the diameter of each wheel. When it controls the vehicle along the driving lane, the control is performed in consideration of the above vehicle information.

When the vehicle is driven on a curved road, the steering device 134 is rotated based on the curvature of the driving lane. When the steering device 134 is rotated, front wheels rotate at a predetermined angle. Since the front wheels and the rear wheels are spaced apart at a predetermined interval, the curvature radius at which the vehicle rotates changes based on the interval between the front wheels and the rear wheels. This change is calculated, and the steering device is controlled so as to rotate the front wheels at an angle matching with the curvature radius of the driving lane.

When the steering device 134 is controlled, the rotation of the steering device 134 is controlled by installing a motor (not illustrated) at the steering device 134. At this time, the motor (not illustrated) equips with an encoder (not illustrated), which allows the ECU 131 to recognize the rotation angle of the motor (not illustrated). The rotation angle of the steering device 134 can be accurately controlled in such a way to accurately control the rotation of the motor (not illustrated) with the aid of the ECU 131.

A rotation detection sensor 135 is installed at a portion where the wheel of the vehicle is installed. In the driving control module 130, the circumference of the wheel based on the diameter of the wheel is calculated and multiplied by the revolution of the wheel detected by the rotation detection sensor 135, thus obtaining a distance that the vehicle has been actually driven.

To this end, it is possible to determine where the vehicle positions on the driving lane set by the mapping module 110.

In the mapping module 110, when a driving lane is set, the information on a crossroad, a crosswalk, a tunnel, a signal lamp and a regulated speed on a road on the driving lane are set together. In the driving control module 130, the circumference of the wheel is multiplied by the revolution per unit time detected by the rotation detection sensor 135, thus obtaining an actual speed of the vehicle. The speed can be adjusted by increasing or decreasing the output of the engine 132 installed at a vehicle based on the regulated speed of the current road with the aid of the above calculated value.

When it needs to urgently reduce the speed, the speed of the vehicle is decelerated by controlling the brake 133, thus coping with an emergency situation.

Meanwhile, if the vehicle is driven a predetermined distance in such a way that the automatic driving device 100 controls the vehicle, a predetermined error inevitably occurs even though the vehicle is very accurately controlled. Here, there is provided an error correction module 120 so as to correct such an error of the vehicle.

The error correction module 120 is configured to receive in real time the current position of the vehicle from the navigation device 200, and the position on the driving lane of the vehicle being controlled by the automatic driving module 130 is compared with the current position received from the navigation device 200. If the error exceeds a predetermined level, the error correction module 120 may correct the driving lane based on the current position of the vehicle received from the navigation device, thus correcting the error.

Here, the range of the error may be set by the driver. If the range of the error is set too wide, since the difference between the actual position of the vehicle and the position of the vehicle that the automatic driving module 130 recognizes is too large, the safety driving may be threatened. If the range of the error is set two small, it needs to frequently correct the driving lane. While the driving lane is being corrected, the functions of the remaining modules may be limited, whereupon an appropriate range of the error should be set for the sake of safety driving.

The driving safety module 140 allows to control the vehicle so as to avoid any collision with other vehicles or things when the vehicle is driven while detecting other vehicles or things being near the vehicle.

At this time, a distance detection sensor 142 may be installed at front, rear, left and right sides of the vehicle so as to detect other vehicles or things being near the vehicle, thus detecting the distance to other things or vehicles being near the vehicle.

Here, it is preferred that the distance detection sensor 142 may be installed in a diagonal direction of the vehicle, not at the front, rear, left and right sides of the vehicle so as to more accurately detect any dangerous components near the vehicle, which may allows the vehicle to be driven in safe.

Meanwhile, the driving safety module 140 may include a wireless receiver unit 144. As illustrated in FIG. 5, the wireless receiver unit 144 is configured to receive a signal lamp information that the wireless transmitter unit 310 installed at the signal lamp 300 at a crossroad or a crosswalk transmit.

Therefore, the driving safety module 140 may transmit the received signal lamp information to the driving control module 130, whereupon the vehicle can be controlled in consideration of the signal of the signal lamp, thus allowing the vehicle to be driven in compliance with the signal lamp.

When the driving lane is set in the above way, the information on the crossroad, the crosswalk, and the signal lamp are set together. When the vehicle positions within a predetermined range while the vehicle is being driven as compared with the position where the signal lamp 300 is installed, the driving safety module 140 may obtain from the information on the signal lamp the frequency that the wireless transmitted unit 310 at a corresponding signal lamp 300 transmits so as to have the wireless receiver unit 144 installed in the inside receive only a corresponding frequency, thus preventing any confusion with the signal from other signal lamps 300 being nearby.

A plurality of signal lamps 300 in general are installed at one crossroad. The plurality of the signal lamps 300 installed at one crossroad change their signals operating in sync with one another, whereupon all the signals of the signal lamps installed at one crossroad are transmitted through one wireless transmitter unit 310.

At this time, since the wireless transmitter unit 310 installed at each signal lamp 300 may transmit in real time the signal lamp information using an exclusive frequency, the driving safety module 140 can obtain a frequency of a corresponding signal lamp 300 stored in the information of the driving lane and can receive only a signal corresponding to the corresponding signal lamp 300.

To this end, the driving control module 130 can detect in real time the signal of the signal lamp 300, thus allowing the vehicle to be driven in safe in compliance with the signal.

Meanwhile, the mapping module 110 may store a detailed information on each road. When the driving lane is set, the information on the width and number of the lanes formed on each road on which the vehicle is driven are set.

When the mapping module 110 sets a driving lane, as illustrated in FIG. 6, a main driving lane 510 allowing the vehicle to be directly driven on one lane among the lanes formed on the road is set, and at the same time, an assistant driving lane 520 allowing the vehicle to be driven on other lanes is set.

Therefore, if a corresponding lane is blocked while the vehicle is being driven on the main driving lane 510 or if there is an obstacle, the driving lane being nearest the assistant driving lane 520 is selected as a main driving lane 510, and the lane is changed to the selected driving lane, thus more safely and easily changing the lane.

When the lane is changed, it needs to check if there are other vehicles near the vehicle with the aid of the driving safety module 140, and then the lane is changed.

In addition, the automatic driving device 100 may further include a lane control module 150 which allows to detect a lane so as to control the vehicle not to deviate from the lane on which the vehicle has been driven. The lane control module 150 may include an image process module 152 for processing the images from the camera 400 installed at a front side of the vehicle and is configured to analyze the images processed by the image process module 152, thus determining the lane by comparing the patterns of various lanes (center line, driving lane, shoulder, etc.), so it can determine what lane the vehicle currently positions on.

The thusly determined information is transmitted to the driving control module 130. The driving control module 130 can control the vehicle to immediately return to the normal position if the vehicle has been driven on the wrong lane, not the normal lane, thus preventing any vehicle accident.

As illustrated in FIG. 7, according to another exemplary embodiment of the present invention, the automatic driving device 100 may include a position detection module 160 for detecting the current position of the vehicle. The position detection module 160 is able to determine the current position of the vehicle in such a way to recognize the lane from the images taken by the camera disposed at a front side of the vehicle.

Here, the camera 400 may position at any portion of the vehicle, but the camera 400 is preferably installed at the top of the vehicle so as to take pictures in all the directions of the road, thus effectively taking pictures in both directions of the vehicle.

The image process module 152 disposed in the inside of the lane control module 150 is configured to process the images taken by the camera 400. The lane detection module 154 may compare the thusly taken images with the previously stored lanes, thus determining the lanes.

At this time, the position detection module 160 is able to accurately determine the lane on which the vehicle positions with the aid of the information on the lanes of the left and right sides of the vehicle determined by the lane control module 150.

Since it is possible to accurately determine the position of the vehicle detected based on the information of the navigation and the driving information of the vehicle, namely, the information on where the vehicle positions and the accurate lane on which the vehicle positions detected by the vehicle position detection module 160, the vehicle can be accurately controlled.

In addition, since the remaining configuration is same as the earlier described configuration, the description thereof will be omitted.

Meanwhile, as illustrated in FIGS. 8 and 9, according to further another exemplary embodiment of the present invention, the automatic driving device 100 may include a position detection module 160 for detecting the current position of a vehicle. The position detection module 160 is configured to measure the distance from an edge of the road to the current vehicle, thus determining the position of the vehicle.

Here, the position detection module 160 may include a first transceiver device 165 for transmitting and receiving a high frequency signal, and a second transceiver device 610 spaced apart at a predetermined interval is provided at an edge of the road on which the vehicle is driven, thus receiving the high frequency signal transmitted from the first transceiver device 165 and transmitting a signal to the first transceiver device 165.

At this time, the position detection module 160 is configured to calculate a time that a signal transmitted from the first transceiver device 165 returns back, thus calculating the distance to the second transceiver device 610. Each second transceiver device 610 is assigned an exclusive recognition number. Since it is possible to recognize a signal of each second transceiver device 610, the distance to each second transceiver 610 can be calculated.

To this end, the edges of both side of the road and the position of the vehicle can be accurately calculated. The lane on which the current vehicle positions can be accurately determined with reference to the width of the lane stored in the mapping module 110, thus stably controlling the vehicle.

Meanwhile, the second transceiver device 610 may be installed on the center line formed in the center of the road.

In addition, since the remaining configuration is same as the earlier described configuration, the description thereof will be omitted.

According to still further another object of the present invention, as illustrated in FIG. 10, the automatic driving device 100 of the present invention may include a road state detection module 170 for detecting the state of the road. The road state detection module 170 is configured to process the images taken by the camera 400 provided in the vehicle and to check if there is any dent portion or crack on the road by comparing with the common road and to determine if the size of the checked portion is large enough to interfere with the operation of the vehicle.

If it is determined that the checked portion is large enough to have effect on the operation of the vehicle, the driving lane is changed, and otherwise the vehicle is driven on the initial driving lane.

As not illustrated in the drawings, a storing unit (not illustrated) may be provided in the inside of the automatic driving device 100 so as to store the information of the driving lane on which the vehicle was driven before and control the vehicle based on the stored driving information if the vehicle is driven next time to the same destination or to a nearby destination, thus more stably controlling the vehicle.

When the driving information is stored, the images taken by the camera 400 are stored together with the driving lane. If the vehicle is driven on the lane on which the vehicle was driven before, the vehicle is controlled on a previously stored driving lane, and the vehicle can be controlled while comparing the taken images and the image being taken during the driving, whereupon the vehicle can be driven even on a narrow alley.

At this time, the camera 400 is installed at the top of the vehicle and is configured to take pictures in the direction where the vehicle is being driven. When storing the taken images, the images are stored by matching the current position on the driving lane with the taken images.

In addition, when the vehicle is driven on an alloy where there are little vehicle, namely, in case where the lanes cannot be recognized after the taken images are processed by the image process module 152, a track portion is extracted from the taken images, and a boundary line of the rack is illustrated at an edge of the track portion and is stored. When the vehicle is driven next time on the same route, the vehicle can be controlled more safely with reference to the boundary line of the track.

The images taken by the camera 400 are compared with the previously stored images, thus detecting a special thing or a person which positions in the proceeding direction of the vehicle, whereby any accident can be prevented.

Meanwhile, since the technology for comparing such images is a known technology, the description thereof will be omitted. Since the remaining configuration is same as the earlier described configuration, the description thereof will be omitted.

Referring to FIG. 11, according to still further another embodiment of the present invention, the driving safety module 140 of the automatic driving device 100 of the present invention may include a wireless receiver unit 144 for receiving an external wireless signal. The wireless receiver unit 144 is configured to receive the information of each parking lot 700 transmitted from the wireless transceiver unit 710.

Here, the parking lot 700 is given an exclusive recognition number. The wireless signal containing the exclusive number is transmitted. The information transmitted from the parking lot 700 includes a detailed geographical information of each parking lot 700, and the parking state of the parked vehicle.

The wireless receiver unit 144 refers to a geographical information and a parking state information from the parking lot 700 and the size of the vehicle stored in the driving control module 130 and the size of the wheel and the rotation angle of the wheels rotating when the steering device 134 is operated. The mapping module 110 according to the present invention is configured to select the position where the vehicle parks and form a specific driving lane to move the vehicle to where the vehicle parks, whereupon the vehicle can be automatically controlled and parked with the aid of the driving control module 130.

At a predetermined position of each parking lot 70, there is provided a third transceiver device 620 which allows to accurately detect the position of the vehicle on the parking lot 700 with the aid of the first transceiver device 165 disposed at the vehicle, which makes it possible to accurately control the vehicle.

At this time, the third transceiver device 620 may be installed at an edge portion of the parking lot 700 or in a corner portion, which helps to accurately determine the position of the vehicle in the parking lot 700.

According to still further another exemplary embodiment of the present invention, the camera 400 installed at the vehicle takes pictures of the forward scenes of the vehicle. If the vehicle has moved near a crossroad, the image process module 152 may analyze the image of the signal lamp 300 in the direction that the vehicle is intended to move, among the images taken by the camera 400, thus determining the current signal of the signal lamp.

Here, the driving control module 130 may store various samples obtained based on various types of the signal lamp and the signals on the signal lamps. The current signal of the signal lamp can be determined in such a way to compare the samples with the image of the signal lamp captured by the image process module 152.

According to still further another exemplary embodiment of the present invention, the wireless receiver unit 144 of the driving safety module 140 may receive an information on the communication network which is generally used. If the user of the vehicle which stays at a distance region transmits a destination of the vehicle on a communication terminal, for example, an internet terminal (not illustrated) or a smart phone, the wireless receiver unit 144 receives the designation through the communication network, and the driving control module 130 detects the same and controls the vehicle to be driven to the destination, which is performed unmanned.

To this end, even though the user stays in a distant region spaced apart from the vehicle, if the user needs his vehicle, the user sets the destination of the vehicle on the smart phone or the computer, and the vehicle recognizes such as a control and may move unmanned, whereupon the user can more conveniently use the vehicle.

According to still further another exemplary embodiment of the present invention, a detection module (not illustrated) may be separately provided in the inside of the vehicle. For this, the vehicle is able to detect a key or a predetermined RFD card that the user has. When the detection module of the vehicle detects that a user enters a predetermined range, the vehicle may output a certain horn or may output a set sound through speakers or may control an emergency lamp to be turned on, by which the user can recognize the position of the vehicle, thus easily locating the position of the vehicle.

If the user does not has a key or a RFID card, the image of the user can be received from the camera 400, and the process module 152 determines if the user is a registered user. In case of the registered user, all the functions of the vehicle can be used if the user does not have any key or RFID card.

Meanwhile, according to still further another exemplary embodiment of the present invention, the driving safety module 140 provided a the vehicle can equip with a separate wireless transceiver device (not illustrated), so the current state of the vehicle can be transmitted to a nearby vehicle through a wireless transceiver device (not illustrated), and the nearby vehicle receives through the wireless receiver unit 144 provided at the driving safety module 144, thus checking in real time the information of the nearby vehicles.

To this end, it is possible to know in real time if any door of the vehicle is closed complete. When a person passes by near a corresponding vehicle, the person can be careful, thus coping with any emergency situation which may occur since the door is suddenly opened.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

The present invention relates to an automatic driving system for a vehicle, and in particular to an automatic driving system for a vehicle wherein when a driver sets a destination on a navigation device, a vehicle can be controlled to be automatically driven to the set destination in consideration of traffic signals, nearby vehicles and things.

What is claimed is:

1. An automatic driving system for a vehicle, comprising:
a mapping module which receives a route information set on a navigation device installed at a vehicle and converts a distance, a direction and a rotation angle into an actual measurement data and sets a driving lane; and
a driving control module which allows the vehicle to be driven on the driving lane set by the mapping module.

2. The system of claim 1, wherein the driving control module is configured to store a vehicle information on a position of each wheel, a rotation angle of each wheel rotating when a steering device is operated, and a diameter of each wheel.

3. The system of claim 2, wherein the driving control module is configured to control an engine, a brake and the steering device in consideration of the vehicle information for the vehicle to be driven on a driving lane with the aid of an ECU (Electronic Control Unit) provided at the vehicle.

4. The system of claim 1, further comprising:
an error correction module which is able to correct a driving lane based on the current position of the vehicle received from the navigation device by comparing the current position of the vehicle received from the navigation device with the position on the driving lane.

5. The system of claim 1, further comprising:
a driving safety module which allows to prevent any collision in such a way to detect other vehicles or things near the vehicle with the aid of a distance detection sensor installed at front, rear, left and right sides of the vehicle.

6. The system of claim 5, wherein the driving safety module includes a wireless receiver unit which is able to receive a signal lamp information from a wireless transmitter unit installed at a signal lamp at a crossroad or a crosswalk.

7. The system of claim 1, wherein when setting a driving lane, the mapping module sets together information on a crossroad, a crosswalk, a tunnel, a signal lamp, a regulated speed of a road, and an exclusive frequency of each signal lamp.

8. The system of claim 1, wherein the mapping module is configured to store information on the width and number of the lanes formed on each road on which the vehicle is driven and form a main driving lane allowing the vehicle to be directly driven on any of the lanes formed on the road, and an assistant lane allowing the vehicle to be driven on other lanes.

9. The system of claim 1, further comprising a lane control module for detecting the lane in order for the vehicle not to deviate from the lane.

10. The system of claim 9, wherein the lane control module includes:
an image process module which is configured to process the images transmitted from a camera installed at a front side of the vehicle; and
a lane detection module which is configured to determine each lane by analyzing the pattern of each lane in the images processed by the image process module.

11. The system of claim 10, further comprising a position detection module for detecting the position of the vehicle, and the position detection module is configured to determine the lane where the vehicle positions on the road with the aid of the lane information detected through the image process module and the lane detection module.

12. The system of claim 8, further comprising:
a position detection module for detecting the position of the vehicle, and the position detection module includes a first transceiver device for transmitting and receiving a high frequency signal, and a second transceiver device is installed spaced apart at a predetermined interval at both sides of the road so as to receive the signal from the first transceiver device and transmit again, and the position detection module is configured to determine the lane on which the vehicle positions on the road with the aid of the information on the distance between the both sides of the road and on the width of the lane which are detected based on the signal transmitted through the first and second transceiver devices.

13. The system of claim 1, further comprising:
a road state detection module for determining the state of the road, and the road state detection module is configured to determine if there is any crack or dent on the road in such a way to analyze the images taken by the camera installed at the vehicle.

14. The system of claim 1, wherein the storing unit includes a storing part for storing a driving information which contains the driving lane on which the vehicle was driven before and the images taken by the camera installed at the vehicle, and the images are stored matched with the positions on the driving lane.

15. The system of claim 14, wherein when the vehicle is driven on the lane where the vehicle was driven before, the vehicle is controlled while comparing the images stored in the storing unit with the images taken by the camera.

16. The system of claim 2, wherein the wireless receiver unit receives, through the wireless transceiver unit provided at the parking lot, a geographical information on the parking lot where the vehicle parks and the information of a space in which the vehicle is parking, and the mapping module forms a specific driving lane to move the vehicle from the current position of the vehicle to a position where the vehicle parks, thus parking the vehicle.

17. The system of claim 16, further comprising:
a position detection module for detecting the position of the vehicle, and the position detection module equips with a first transceiver device for transmitting and receiving a high frequency signal, and a third transceiver device is provided at an edge portion of the parking lot so as to receive a signal of the first transceiver device and transmit again, and the position detection module is able to measure the position of the vehicle with the aid of information on an edge portion and the geographical information on the parking lot which are detected through the signals transmitted from the first and third transceiver devices.

18. The system of claim 2, wherein a signal lamp image is extracted from the image taken by the camera provided at the vehicle, and the extracted signal lamp image is compared with the image of the signal lamp stored by pattern in the driving control module, thus determining the current signal.

19. The system of claim 14, wherein a boundary line is added to an edge of each of both sides of the road in the taken images and is stored.

20. The system of claim 15, wherein whether or not any obstacle is on the road is detected in such a way to compare the image taken during the driving of the vehicle with a previous image.
